(19) United States
(12) Patent Application Publication
(10) Pub. No.: US 2004/0039654 A1
(43) Pub. Date: Feb. 26, 2004

(54) Device and method for carrying out a remote e-business transaction

(76) Inventors: Stephan Schambach, Jena (DE); Frank Gessner, Jena (DE); Thomas Boehm, Leizig (DE); Trevor Pocock, Jena (DE)

Correspondence Address: Richard A Nebb, Dergosits & Noah, Suite 1450, Four Embarcadero Center, San Francisco, CA, 94111, US

(21) Appl. No.: 10/381,026

(22) PCT Filed: Sep. 18, 2001
(86) PCT No.: PCT/EP01/10793

(30) Foreign Application Priority Data
Sep. 18, 2000 (EP) 00120399.1

(51) Int. Cl. G06F 17/60

(52) U.S. Cl. 705/26

(57) ABSTRACT

The present invention provides a device and a method that make it possible to select business items in an ordering system and to initiate a transaction relating to said business item in order then to forward this transaction request to the transaction system, which then executes the transaction relating to the applicable terms of said transaction system, that is to say, for example, taxes, shipping costs, discount systems, optionally with the inclusion of special client profiles, and sends back the outcome of this transaction processing to the ordering system serving to initiate the transaction processing.

The present invention relates to a method, computer system and computer program for executing transactions, in particular in a decentralized system of server computers that are interconnected preferably via a medium suitable for data transmission, for example the Internet.

For the purpose of better comprehension of the invention, but not for the purpose of limiting its scope, the following terms shall be explained.

A client may be a personal computer, an organizer, such as, for example, Psion mxpro or Palm V, or even a mobile telephone or the like, by means of which a connection can be made to a server in the system according to the invention via a medium suitable for data transmission, for example the Internet, in order to retrieve data records and, in particular, to initiate business transactions on the servers of the system according to the invention.

A server is a data processing unit by means of which data records are processed, managed and kept ready for retrieval. In this connection, a server has at least one interface for transmitting and receiving data records over a medium suitable for data transmission, at least one interface for transmitting or forwarding and receiving transaction requests and a memory unit or at least an interface for accessing a memory unit for storing and managing data records, for example a data base.

If the networking of the computer system is mentioned, the networking of the servers can be implemented by any medium that is suitable for data transmission. For example, for the purpose of better comprehension, mention may be made at this point of the Internet or Intranets, respectively, and Extranets as suitable media for networking servers, transmission taking place by cable, radio or satellite.

The management of business items means in this context, on the one hand, the presentation of, for example, products of a manufacturer or dealer, services of a service provider or the like by describing, presenting and categorizing the products, services or the like within a catalogue structure on a server and, on the other hand, the preparation and execution of transactions relating to said products, services or the like.

Described as business items within the scope of this description of the invention are the relevant data records that serve to present a product or a service or to execute a transaction relating to said products or services or the like on a server.

Described as an e-business system is the computer program according to the invention that is installed on the server of the computer system according to the invention and by means of which, for example, products or services of a supplier can be offered and can be ordered by a client over the Internet. For this purpose, the computer program makes possible the creation of catalogue structures for handling, for example, products or services of a supplier and the facility for executing transactions, that is to say orders, relating to the individual products or services.

An e-business system may be, for example, a single-store system, multi-store system, marketplace or a procurement system.

Described as an ordering system in this description is the e-business system according to the invention on a server of the computer system according to the invention in the case where the transaction relating to a business item managed in this e-business system is initiated via the e-business system installed on said server, and described as a transaction system is an e-business system if the e-business system installed on a server of the computer system according to the invention is to execute the transaction for the respective business item.

A server is a transaction server if the e-business system installed on said server is the transaction system. A server is described as an order server if the e-business system installed on it functions as an ordering system. A server on which a plurality of e-business systems is installed may be a transaction and order server at the same time.

The preparation and execution of a transaction means the execution of calculations on the server for certain business items, for example the calculation of shipping costs, taxes, etc., for the selected business items and also, for example, the initiation of the ordering of a respective product or a service.

The prior art includes the fact that an e-business system is operated on a server in the form of a multi-store. In this connection, each individual store can be administrated separately and different business items can be managed in each of the individual stores. In this connection, transactions relating to the respective business items take place in the respective store.

Furthermore, the prior art includes the fact that the customer in a multi-store system can make a list of different business items from the individual stores and then initiate a collective order.

Said collective order is, however, possible only if the operator of said multi-store system has installed a transaction routine for all the shops. The individual stores then receive a message that one or several of their business items have been ordered.

It is furthermore prior art that it is possible to change from one e-business system (for example, “SAP B2B procurement”) to other e-business systems in order to select business items there and to transfer each of them there into a “virtual shopping basket” or a shopping list. The method makes it possible to transfer the individual shopping baskets from the respective e-business systems to a shopping basket of the original e-business system. In said system, the transfer takes place via an OCI (open catalogue interface) so that, without a change from the e-business system to the store of the respective supplier and the creation of a shopping basket in said store, a synchronous interaction for the purpose of exchanging data is not possible.

Accordingly, the object of the present invention is to provide a method and a computer system that eliminates the above-described disadvantages and problems of the prior art.

### SUMMARY OF THE INVENTION

The present invention provides a device and a method that make it possible to select business items in an ordering system and to initiate a transaction relating to said business item in order then to forward this transaction request to the transaction system, which then executes the transaction relating to the applicable conditions of said transaction system, that is to say, for example, taxes, shipping costs, discount systems, optionally with the inclusion of special client profiles, and sends back the outcome of this transaction processing to the ordering system serving to initiate the transaction processing.

In this connection, the business items can be entered manually into the ordering system or be transferred via a medium suitable for data transfer from another e-business system to the ordering system and automatically incorporate it in the ordering system.

The method according to the invention makes it possible for the client to initiate transactions relating to one or more business items, the transaction retrievals with regard to the business items whose transactions are not to be executed on the ordering system are forwarded to the respective transaction systems that then execute the transaction relating to the respective business items. The forwarding of the transactions may, in this connection, take place optionally. In this connection, the identifier of the ordering system and, optionally, a client profile are transferred to the respective transaction systems and can therefore be included in the transaction routine on the transaction systems.

After execution of the transaction has taken place, the outcomes resulting from the transaction are sent back to the ordering system. They can then immediately be forwarded to the client or included in a further transaction routine on the ordering system and only then is the outcome of said transaction executed on the ordering system forwarded to the client.

For the method according to the invention to be capable of application, the transaction and ordering systems may be installed on one server or on separate, distributed servers.

A transaction request may also be forwarded via a multiplicity of transaction systems connected in series.

The invention furthermore proposes a computer program according to claim 19 and a data structure according to claim 21. Developments of the invention emerge from the sub-claims.

### ADVANTAGES OF THE INVENTION

The method according to the invention offers the advantage that it is possible, for example, for operators of the individual e-business systems to link themselves to a multiplicity of other e-business systems with their respective special price model.

If business items are ordered on an ordering system, the order is automatically forwarded to the appropriate transaction system and processed there in relation to the respective applicable conditions (shipping costs according to customer destination, taxes, discount) and a specific calculation outcome is sent to the ordering system which is then forwarded to the client for inspection.

On the other hand, for example, operators of portals or marketplaces can link a multiplicity of suppliers to their marketplace without the marketplace operator having to install or adapt complicated transaction logic for every individual supplier depending on his own business models.

Although the marketplace operator has a multiplicity of, for example, products or services on offer, much of the traffic (load) distributes itself over the transaction systems connected, which, after all, process the actual transactions.

The client may find, for example, various suppliers relating to a certain product on a marketplace. The method according to the invention offers the advantage in this case that the client can request prices from the respective suppliers without leaving the marketplace and changing over to the respective e-business system of the individual suppliers.

For example, one of the suppliers may give the client a personal discount for orders that can also be included in the order via the marketplace since, in accordance with the method according to the invention, the client data are also transferred with the transmission of the request.

A computer program product may comprise any suitable memory medium on which the computer program that executes the method according to the invention is stored.

Further tasks, advantages, features and embodiments of the present invention become obvious in connection with the more detailed description of preferred exemplary embodiments of the invention and from the attached drawings.

### BRIEF DESCRIPTION OF THE DRAWINGS

FIG. 1 shows a diagrammatic representation of an embodiment of the computer system according to the invention.

FIG. 2 is a diagrammatic representation of the steps in the method in accordance with one embodiment of the method according to the invention.

FIG. 3 is a diagrammatic representation of a data structure of a business item that is transmitted from an ordering system to a transaction system of the computer system according to the invention for processing.

FIG. 4 is a diagrammatic representation of the forwarding of a transaction request of a client from an ordering system to a transaction system or the feedback to the client relating to the outcome of the transaction in accordance with one embodiment of the method of the present invention.

### DETAILED DESCRIPTION OF THE INVENTION

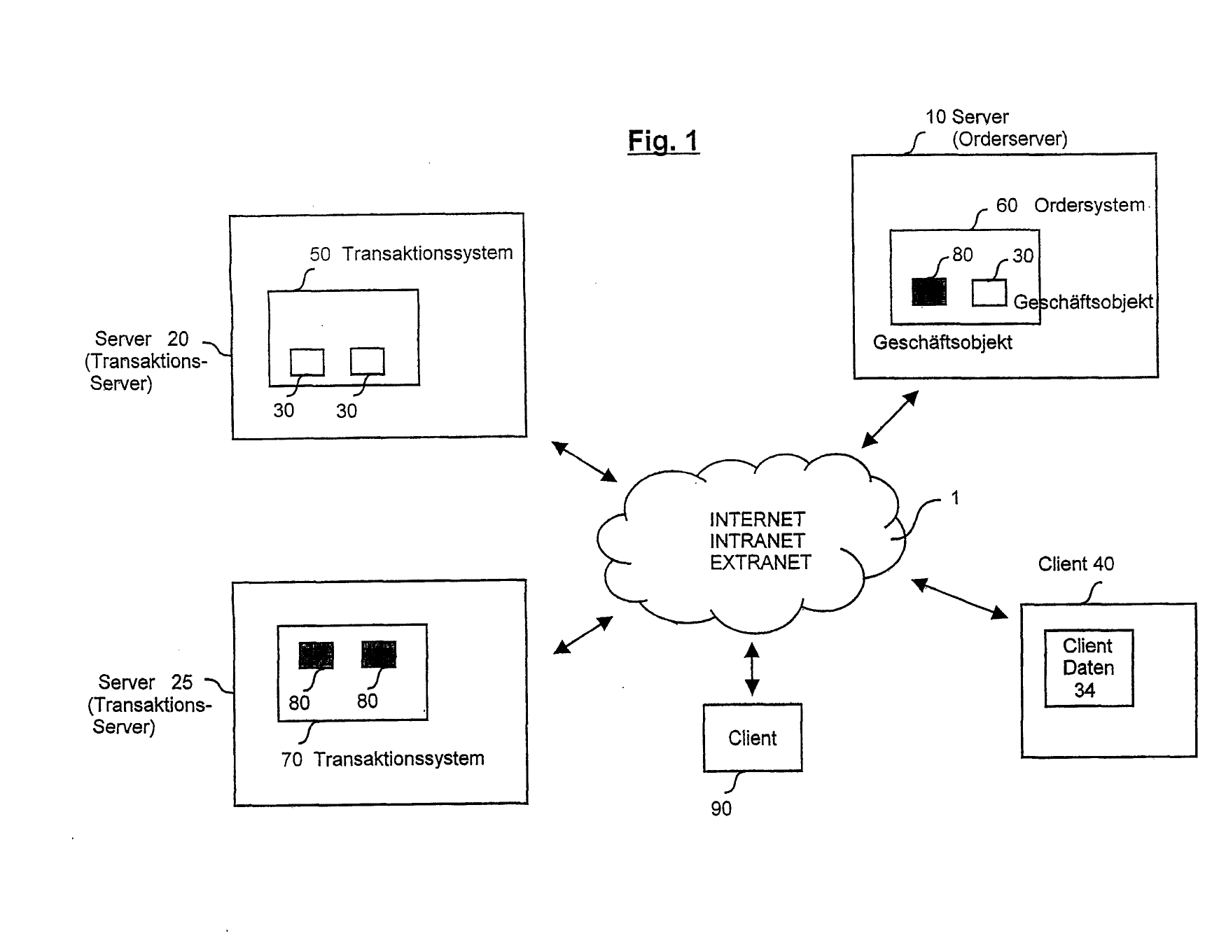

The embodiment of the invention shown in FIG. 1 shows an interconnected computer system that comprises at least two servers, a transaction server (20, 25) and an order server (10), and a client (40) that are interconnected via the Internet, an Extranet or an Intranet (1). It is also possible, however, that only one server (10) is connected to the client (40). In this case, the individual server is both an order server and a transaction server.

At least one business item (30, 80), for example products of one manufacturer or dealer or, for example, services is handled by means of the e-business system according to the invention on the respective servers (10, 20, 25), but at least on the order server (10) of the computer system according to the invention.

An ordering system is distinguished by the fact that any user can retrieve via his client the data of business items, which are, after all, data records, for inspection by the client in order to decide whether a transaction, such as, for example, an ordering of a sales product, should be executed. In that case, the business items can also be requisitionable for the client by the ordering system since, in the case of a transaction server, the request for the business items by the user does not necessarily exist.

For example, the business items may be stored only in data bases which a user cannot access from the outside because an appropriate device for displaying the business items has not been provided for a user accessing from the outside on the transaction server. The order server (10) therefore undertakes, expressed generally, the function of a marketplace for the business items that are created or installed, on the basis of data records from data bases of suppliers connected to the marketplace, on offer to the clients likewise connected thereto. In order to ensure a problem-free communication between all the parties to the transaction, a unified interface, which is likewise provided by the present invention, is necessary between possibly differing e-business system types.

It is also possible the relevant business items are handled on all the servers of the computer system. For this purpose, there is installed on the servers the computer program according to the invention, which creates an e-business system. In this connection, a plurality of e-business systems (ordering and transaction systems) may be installed on a server. Said e-business systems are capable of executing separately administrable calculation routines for every business item.

There may be facility for a multiplicity of clients 40, 90 to set up a connection to at least one of said servers, for example via the Internet, in order to requisition the respective business items handled by the installed e-business systems and, for example, to have business items shown on the display unit of the client computer, for example on the viewing screen of a personal computer or in the display of a mobile telephone.

The business items 30, 80 can be incorporated into the e-business systems 50, 60, 70 in various ways.

1. Manually

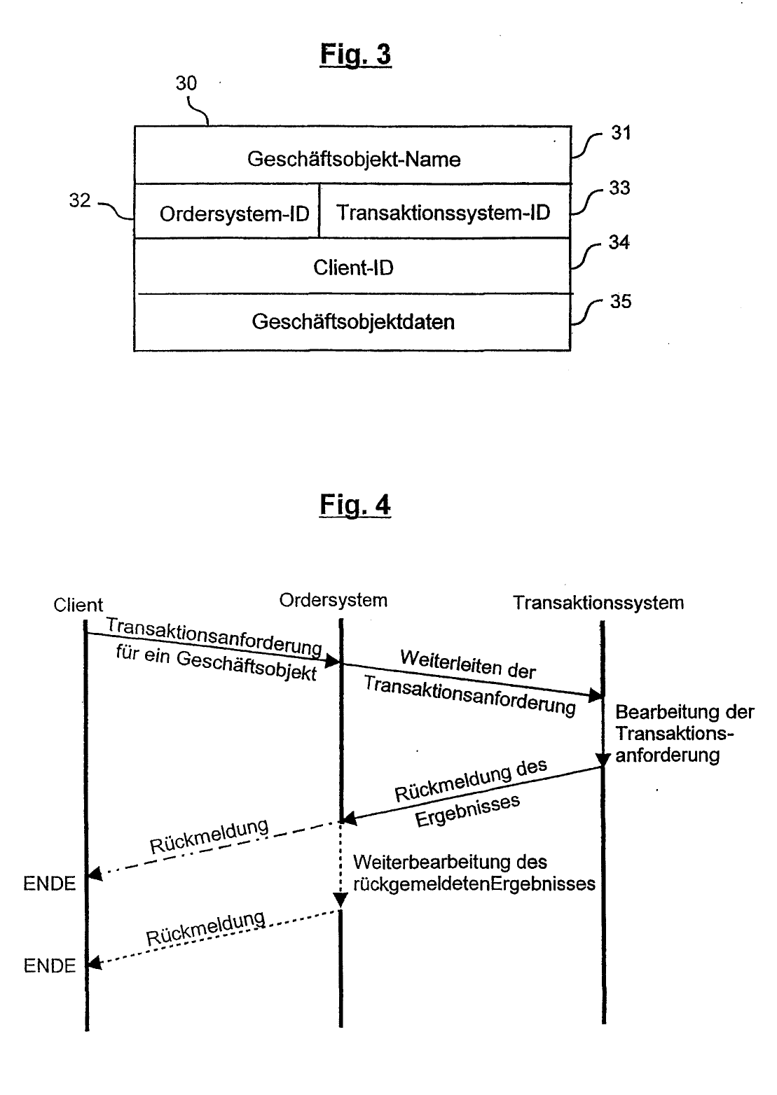

On the one hand, said business items can be entered manually into the ordering system 60. In this case, said business items can be assigned an identifier 33, as shown in FIG. 3, of the e-business system that is to execute, as transaction system 50, transactions relating to the respective business items. Furthermore, the data structure shown in FIG. 3 of a business item 30, 80 may be assigned a business item name or ID 31.

The identifiers 32 and 33 may, for example, be the IDs of the ordering or transaction system.

2. Content transfer

The business items 30, 80 may, however, also be incorporated online by transmitting the business items 30, 80 from one e-business system 50, 60, 70 to another e-business system 50, 60, 70, for example via the Internet. The nature and scope of the transmission depends on so-called “business rules” that are agreed between the operators of the e-business systems.

Such “business rules” may stipulate, for example, which business items are to be transferred and in what form the first transmission or later updating is to take place, for example by the business items being provided by the transaction system and, optionally, requisitioned by the ordering system and, for example, by updatings with regard to the business items transferred being automatically transferred by the transaction system immediately after the update or in a stipulated time interval to the ordering system.

In this connection, the form in which the first transfer or later updates are to take place may also be agreed.

For the purpose of data transfer, XML may for example serve as data format and ICE as transmission protocol.

The incorporation of the business items into the ordering system 60 depends on the respective user purpose or transfer purpose. For example, the business items may be classified according to their type into the respective categories of the ordering system 60 or under the name of the respective supplier, who may, for example, be an operator of the transaction systems 50 or 70.

To process a transaction, intermediate steps are, as a rule, necessary whose nature and scope depends on the respective business model or the presentations of the supplier of the respective business items.

For example, any taxes or dispatch costs still accruing have to be calculated or, alternatively, the respective supplier grants discounts in certain cases so that the transaction routines of the servers of the computer system or of the e-business systems installed on said servers can be distinguished from one another.

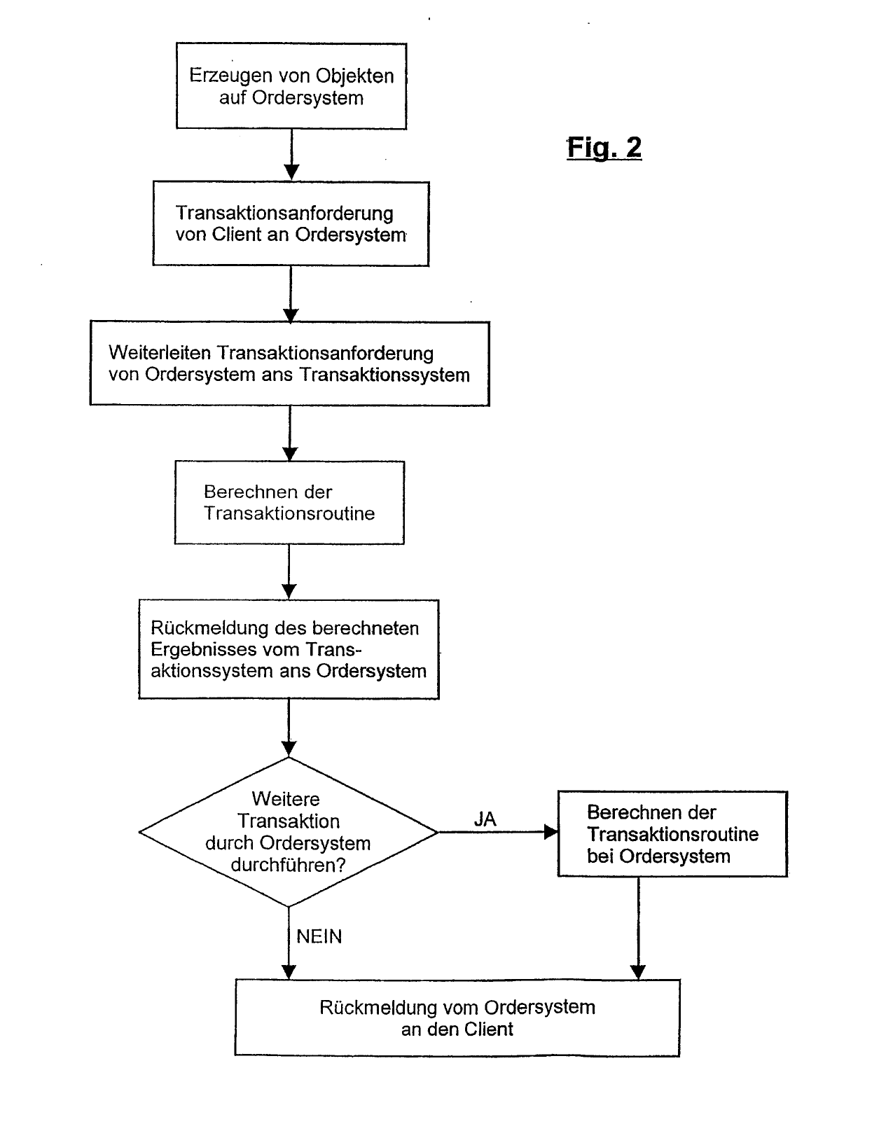

In the case of transaction requests from a client that are received by a server 10 and relate to business items 30 that the ordering system 60 of the order server 10 does indeed have in stock for requisitioning, but the transactions relating to said business items are to be executed on the transaction system 50 of the transaction server 20, the invention therefore makes it possible to forward said transaction request to the transaction system 50 (see also FIGS. 2 and 4). In this event, the identifier 32 of the ordering system 60 and the data 34 of the client 40, who initiates the transaction, are optionally also transferred to the transaction system 50. On the basis of the identifier 32 of the ordering system 60, the transaction system 50 recognizes the ordering system that initiated the transaction request so that, for example, in the case where the transaction system 50 is connected to a plurality of ordering systems, the special “business rules” are applied between said transaction system 50 and the ordering system 60.

One of said “business rules” could be, for example, the crediting of a commission at a certain level for said transaction in favour of the ordering system.

The client data 34 may, for example, be of use to the transaction system for the cost calculation, such as, for example, shipping costs as a function of the location of the client and also for certain special arrangements, such as, for example, special client discounts.

After the execution of the transaction, a feedback then takes place to the ordering system 60 that corresponds to the outcome of the transaction routine executed by the transaction system 50 on the transaction server 20. This feedback can then be forwarded to the client 40 or be further processed by the ordering system on the order server.

In a further embodiment of the invention, the outcome of the transaction executed on the transaction system 50 can be included in a further transaction routine of the ordering system 60. Only after that is the message relating to the overall outcome of the transaction routine conveyed to the client (see FIG. 2, penultimate step).

This is necessary if the operator of the ordering system wishes, for example, to pass a commission to the client or the order should be invoiced in principle by the operator of the ordering system 60 and, therefore, only an applicable calculation of the transaction system 50 for the relevant business item is also to be included in its own calculation.

This may likewise be necessary if, for example, it is agreed between the ordering system and the client that the client is credited points within the framework of a point bonus program for a transaction that he requests via the ordering system or the client again receives a discount from the ordering system.

A further reason could, for example, be the collection of statistical data about the frequency of the transactions requested by the ordering system 60 on the server 10 relating to the respective business item.

The method according to the invention shown in FIGS. 2 and 4 offers, in this connection, a further embodiment of the facility that the client can combine the business items of his choice on the order server 10 and can then initiate an overall transaction relating to the selected business items. In this connection, parts of said overall transaction may be business items of different transaction systems.

For example, business items could, however, also be included whose transactions are to be executed by the ordering system 60. In the case of these business items, the ordering system 60 is at the same time also a transaction system.

The present invention makes it possible to split up the overall transaction into individual transactions relating to individual business items and to forward them to the respective transaction systems 50, 70 with the identifier 32 of the ordering system 60 and, optionally, the client data 34 being passed on.

In that case, the respective transaction routines are executed for the business items concerned on the transaction systems 50, 70. When the latter are concluded, an appropriate message is conveyed to the ordering system 60, which forwards said message separately or together with the other feedback items with regard to the other business items to the client 40.

In a further embodiment of the invention, for example, the forwarding of the transaction request takes place optionally. For example, this may depend on whether the operator of the ordering system 60 can complete the transaction or not, for example depending on whether, in the case of a goods order, he has said goods in stock at the time and can consequently supply them himself.

In addition, it is possible that a transaction request is forwarded from an ordering system to a transaction system, but the latter finds that it does not execute the transaction itself but forwards it in turn to a further transaction system until a transaction system is found that executes the transaction. The outcome of the transaction is then fed back to the ordering system again in the same way.

In a further embodiment of the invention, the ordering system and the transaction system may also be installed on one and the same server. Said server then functions at the same time both as order server (10) and as transaction server.

The general explanations cited above will now be made still clearer on the basis of a graphic example by reference to FIGS. 1 to 4.

Business items 30, for example “XY saws” are transferred via an e-business system 50 on a server 20 whose operator is, for example, the tool producer “XY GmbH” to another e-business system 60 on a server 10 whose operator is, for example, the tool retailer “ABC GmbH” and is incorporated there into the e-business system 60 of the server 10. In this case, the server 20 functions as a transaction server and the server 10 as an order server.

Via the ordering system 60, the business items 30 of the transaction system 50, that is to say, in this case, the “XY saws”, can now also be called up by a client 40, for example, for display on his viewing screen in the form of an HTML page. The client 40 can execute transactions via the ordering system 60 relating to said business items 30, in this case, for example, he can order the “XY saws”, and this results in a transaction request by the client 40 to the ordering system 60 of the server 10.

The method according to the invention makes it possible that, in the case where a client 40 initiates a transaction relating to a business item of the transaction system 50 via the ordering system 60, this transaction initiation is forwarded to the transaction system 50, with the delivery of the business items 30 to be processed, including the identifier 32 of the ordering system 60, the business item data 35 and, optionally, the client data 34.

The appropriate transaction routine, which may be, for example, an order, the calculation of taxes or shipping costs or the like, is then executed on the transaction system 50 for the business items 30 concerned, in this case, for example, for “XY saws”.

The outcome of the execution of the transaction on the transaction system 50 is then fed back to the ordering system 60. This feedback can then be forwarded to the client 40.

If the client 40 initiates an overall transaction for a plurality of business items 30, 80 via the ordering system 60 and this list also includes business items whose transaction should be executed by different transaction systems 50, 70, for example, the “XY saws” by the transaction system 50 on the server 20 of “XY GmbH”, but also “ZQ hammers” as business items 80 of the transaction system 70 on the server 25 of ZZ GmbH, individual transactions relating to the individual business items are forwarded by the method according to the invention to the respective transaction systems.

Furthermore, there is the possibility of making the forwarding of the transaction relating to a business item optional. For example, the operator of the ordering system 60 and the operator of the transaction system 50 may have arranged that the transaction can also be executed by the ordering system 60, but only with the proviso that the operator of the ordering system 60 can deliver the ordered products or the service himself only if it is no longer possible for him to perform the service, for example if his stock does not comprise the product ordered or the service cannot be performed because of deadline difficulties, is the transaction forwarded to the transaction system 50.

If, therefore, the wholesaler, as operator of the ordering system 60, no longer has any “XY saws” in stock, the transaction is automatically forwarded to the transaction system 50 of “XY GmbH”, and the transaction and, consequently, the ordering on the basis of the terms of “XY GmbH” then takes place there. From the disclosure of the description and the drawings, which have only an exemplary nature, and also from the claims, it is obvious to a person skilled in the art that the invention can be amended or modified in a simple way without departing from the scope of the present invention. Furthermore, it goes without saying that the embodiments of the above-described invention can be implemented both by software means and by hardware means and also by a combination of the two.

1. Method of executing a transaction in a server/client environment that comprises the following steps
a) creation of at least one business item (30, 80), which corresponds in each case to a data record, in an ordering system (60), wherein the business item comprises an identifier (33) of a transaction system (50) that executes a transaction associated with the business item;
b) transmission of at least one transaction request for a respective business item from at least one client (40) to the ordering system (60) that handles the business item;
c) forwarding of the transaction request to the transaction system (50) that corresponds to the identifier of the transaction system of the business item;
d) execution of a transaction routine on the transaction system (50) for the respective business item;
e) feedback of the outcome resulting from the transaction routine to the ordering system (60); and
f) forwarding of the transaction outcome fed back by the ordering system (60) to the client (40).

2. Method according to claim 1, wherein ordering system (60) and transaction system (50) are installed on different servers connected via a medium suitable for data transmission.

3. Method according to claim 1, wherein the forwarding step (c) of the transaction request and the feedback step (e) of the outcome take place via a plurality of interconnected transaction systems (50).

4. Method according to claim 1, 2 or 3 furthermore comprising the following steps :
determining, after the outcome of the transaction routine has been fed back from the transaction system (50) to the ordering system (60), whether a further transaction has to be executed by the ordering system (60) with the outcome fed back;
if that is so, execution of the further transaction by the ordering system (60) with subsequent feedback of the outcome of the further transaction to the client (40), and if it is not so, feedback of the transaction outcome of the transaction system (50) to the client (40).

5. Method according to claim 1, wherein the business item is created by manual incorporation of the business item (30, 80) in that said business item is assigned an identifier (33) of the e-business system that executes the transactions relating to said business item as transaction system (50), and an identifier (32) of the e-business system that is assigned as ordering system (60) to said business item.

6. Method according to claim 1, wherein the business item (30, 80) is created as incorporation of the business item by transferring the business item from one business system, in particular from the transaction system (50), to another e-business system, in particular the ordering system (60).

7. Method according to claim 1, furthermore comprising the following steps
preparation of a client profile (34) for identifying the client (40) that is assigned to the business item (30), in relation to which the client (40) transmits a transaction request to the ordering system (60).

8. Method according to claim 1, wherein transaction requests that are an overall transaction request for a multiplicity of business items are forwarded to different transaction systems (50, 60, 70) in order to execute the transaction for the individual business items (30, 80) in the associated transaction system (50, 70).

9. Method according to claim 8, wherein one of the transactions is executed by the ordering system (60).

10. Method according to claim 1, wherein a multiplicity of transaction requests from at least one client (40) is transmitted to the ordering system (60); furthermore comprising the following steps :
forwarding of the transaction requests as overall transaction request to the transaction system (50);
execution of a transaction routine in each case for each transaction request of the overall transaction request on the transaction system (50); and
feedback of the resulting outcomes to the ordering system (60); and forwarding of the transaction outcomes fed back from the ordering system (60) to the client (40).

11. Method according to claim 10, wherein the overall transaction request is split up so that the transaction requests whose business items have an identical identifier (33) of a transaction system
(50, 70) are forwarded to the appropriate transaction systems for executing the transaction routine.

12. Computer system for executing a transaction in a server/client environment comprising
a) a device for creating at least one business item, which corresponds in each case to a data record, in an ordering system (60) on a server (10) wherein the business item comprises an identifier (33) of a transaction system (50) that executes a transaction associated with the business item;
b) a device for receiving at least one transaction request for a respective business item from at least one client (40) to the ordering system (60) that handles the business item;
c) a device for forwarding the transaction request to the transaction system (50) that corresponds to the identifier of the transaction system of the business item;
d) a device for executing a transaction routine on the transaction system (50) for the business item concerned;
e) a device for feeding back the outcome resulting from the transaction routine to the ordering system (60); and
f) a device for forwarding the transaction outcome fed back from the ordering system (60) to the client (40).

13. Computer system according to claim 12, wherein the client (40) is a personal computer, an organizer or a mobile telephone.

14. Computer system according to claim 12, wherein client (40), transaction system (50) and ordering system (60) are interconnected via a medium suitable for data transmission, such as the Internet, an Intranet or an Extranet.

15. Computer system according to claim 12 that has a server (10) that comprises ordering system (60) and transaction system (50) which together form an e-business system.

16. Computer system according to claim 12, wherein transaction system (50) and ordering system (60) are installed on different servers.

17. Computer system according to claim 16, wherein only the server that has an ordering system (60) handles business items

18. Computer system according to claim 14, wherein the business items are transmitted in the data format XML and ICE serves as transfer protocol.

19. Computer program comprising
instructions that can be executed by a computer in order to cause a computer to execute a method in accordance with one of claims 1 to 10.

20. Computer program product comprising
instructions that can be executed by computer in order to cause a computer to execute a method in accordance with one of claims 1 to 10.

21. Data structure comprising
at least one data record that corresponds to a business item that is created on an ordering system (60) in order to execute the method in accordance with one of claims 1 to 10.

22. Data structure according to claim 21, comprising a transaction system identifier (33), an ordering system identifier (32) and a client identifier (34).
